(19) United States
(12) Patent Application Publication
(10) Pub. No.: US 2024/0144752 A1
(43) Pub. Date: May 2, 2024

(54) VEHICLE INSPECTION SYSTEM AND VEHICLE INSPECTION METHOD

(71) Applicant: TOYOTA JIDOSHA KABUSHIKI KAISHA, Toyota-shi (JP)

(72) Inventor: Yusuke TATESUMI, Seto-shi (JP)

(73) Assignee: TOYOTA JIDOSHA KABUSHIKI KAISHA, Toyota-shi (JP)

(21) Appl. No.: 18/365,743

(22) Filed: Aug. 4, 2023

(30) Foreign Application Priority Data
Oct. 31, 2022 (JP) 2022-174705

(51) Int. Cl. G07C 5/08; G06V 20/56

(52) U.S. Cl. CPC G07C 5/0866; G06V 20/56

(57) ABSTRACT

A vehicle inspection system acquires a first camera image captured by a first camera and a second camera image captured by a second camera, calculates a first optical axis coordinate value from the first camera image and a second optical axis coordinate value from the second camera image, determines whether there is an abnormality in each of the first optical axis coordinate value and the second optical axis coordinate value, and identifies an abnormality factor portion causing an abnormality in one or both of the first optical axis coordinate value and the second optical axis coordinate value from among the first camera, the second camera, and the vehicle body of the vehicle, based on a combination of the presence or absence of the abnormality in the first optical axis coordinate value and the presence or absence of the abnormality in the second optical axis coordinate value.

### CROSS-REFERENCE TO RELATED APPLICATION

This application claims priority to Japanese Patent Application No. 2022-174705 filed on Oct. 31, 2022, incorporated herein by reference in its entirety.

### BACKGROUND

### 1. Technical Field

The present disclosure relates to an inspection system for inspecting a vehicle.

### 2. Description of Related Art

Japanese Unexamined Patent Application Publication No. 2015-191548 (JP 2015-191548 A) discloses an out-of-vehicle monitoring device capable of detecting an optical axis deviation (optical axis abnormality) of a camera in real time under a traveling environment. In this technique, a white line is approximated by an approximate formula of first order and higher degree based on a captured image of an area in front of a vehicle. Then, based on the constant of the approximate formula, a change amount (first lateral movement amount) of a lateral position of the vehicle with respect to the white line when the vehicle travels for a set time is calculated. Further, based on the first-order coefficient of the approximate formula, a change amount (second lateral movement amount) of the lateral position of the vehicle with respect to the white line when the vehicle travels for the set time is calculated. Further, when a difference between the first lateral movement amount and the second lateral movement amount is equal to or larger than a preset threshold value, it is determined that the optical axis abnormality of the camera in the horizontal direction has occurred.

### SUMMARY

When an optical axis abnormality of a camera is detected, a failure of the camera, misalignment of the camera mounted on the vehicle, or the like may be considered as a factor of the optical axis abnormality. In this case, it is difficult for a dealer to identify an abnormality factor portion causing the optical axis abnormality, and there is a possibility that a period required for diagnosis of the vehicle is prolonged. In addition, there is a possibility that repair is performed for a portion where repair is not required.

One object of the present disclosure is to provide a technique capable of identifying the abnormality factor portion causing the optical axis abnormality when the optical axis abnormality of the camera is detected.

A first aspect of the present disclosure relates to a vehicle inspection system for inspecting a vehicle.

The vehicle inspection system includes a computer connected to a first camera mounted on a front portion of the vehicle and a second camera mounted on a rear portion of the vehicle.

The computer is configured as described below.

A first camera image captured by the first camera while the vehicle is traveling is acquired, and a second camera image captured by the second camera simultaneously with capturing the first camera image by the first camera is acquired.

Further, the computer calculates a first optical axis coordinate value from the first camera image and a second optical axis coordinate value from the second camera image.

Further, the computer determines presence or absence of an abnormality in each of the first optical axis coordinate value and the second optical axis coordinate value.

Further, the computer identifies, based on a combination of the presence or absence of the abnormality in the first optical axis coordinate value and the presence or absence of the abnormality in the second optical axis coordinate value, an abnormality factor portion causing the abnormality in one or both of the first optical axis coordinate value and the second optical axis coordinate value from among the first camera, the second camera, and a vehicle body of the vehicle.

A second aspect of the present disclosure relates to a vehicle inspection method for inspecting a vehicle.

The vehicle inspection method includes:
acquiring a first camera image captured by a first camera mounted on a front portion of the vehicle while the vehicle is traveling, and acquiring a second camera image captured by a second camera mounted on a rear portion of the vehicle simultaneously with capturing the first camera image by the first camera;
calculating a first optical axis coordinate value from the first camera image;
calculating a second optical axis coordinate value from the second camera image;
determining presence or absence of an abnormality in each of the first optical axis coordinate value and the second optical axis coordinate value; and
identifying, based on a combination of the presence or absence of the abnormality in the first optical axis coordinate value and the presence or absence of the abnormality in the second optical axis coordinate value, an abnormality factor portion causing the abnormality in one or both of the first optical axis coordinate value and the second optical axis coordinate value from among the first camera, the second camera, and a vehicle body of the vehicle.

According to the present disclosure, the vehicle inspection system acquires the first optical axis coordinate value and the second optical axis coordinate value based on the first camera image and the second camera image acquired while the vehicle is traveling. Further, the vehicle inspection system determines the presence or absence of the abnormality in each of the first optical axis coordinate value and the second optical axis coordinate value. Further, the vehicle inspection system identifies, based on the combination of the presence or absence of the abnormality in the first optical axis coordinate value and the presence or absence of the abnormality in the second optical axis coordinate value, the abnormality factor portion causing the abnormality in one or both of the first optical axis coordinate value and the second optical axis coordinate value from among the first camera, the second camera, and the vehicle body of the vehicle.

Accordingly, even when the optical axis abnormality occurs, the abnormality factor portion is identified in a short time, and further, only the portion for which repair is required is repaired.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a block diagram showing an overview and a specific example of a vehicle inspection system according to a first embodiment of the present disclosure;

FIG. 1B is a diagram illustrating a first camera image 21 according to a first embodiment;

FIG. 1C is a diagram showing a second camera image 31;

FIG. 1D is a diagram showing a pattern between the presence or absence of abnormality of the first optical axis coordinate value FOE1 and the presence or absence of abnormality of the second optical axis coordinate value FOE2;

FIG. 2 is a flowchart illustrating a processing example of the vehicle inspection system according to the first embodiment;

FIG. 3A is a block diagram illustrating an overview and a specific example of a vehicle inspection system according to a second embodiment;

FIG. 3B is a diagram illustrating a pattern for estimating an abnormal factor;

FIG. 4 is a flowchart illustrating a processing example of the vehicle inspection system according to the second embodiment;

FIG. 5A is a block diagram illustrating an overview and a specific example of a vehicle inspection system according to a third embodiment;

FIG. 5B is a diagram illustrating a pattern for estimating an abnormal factor;

FIG. 6A is a flow chart showing an exemplary process of the vehicle inspection system according to the third embodiment; and

FIG. 6B is a flow chart illustrating an exemplary process of the vehicle inspection system according to the third embodiment.

### DETAILED DESCRIPTION OF EMBODIMENTS

A vehicle inspection system and a vehicle inspection method according to an embodiment of the present disclosure will be described with reference to the accompanying drawings.

### 1. Embodiment 1

### 1-1. Outline

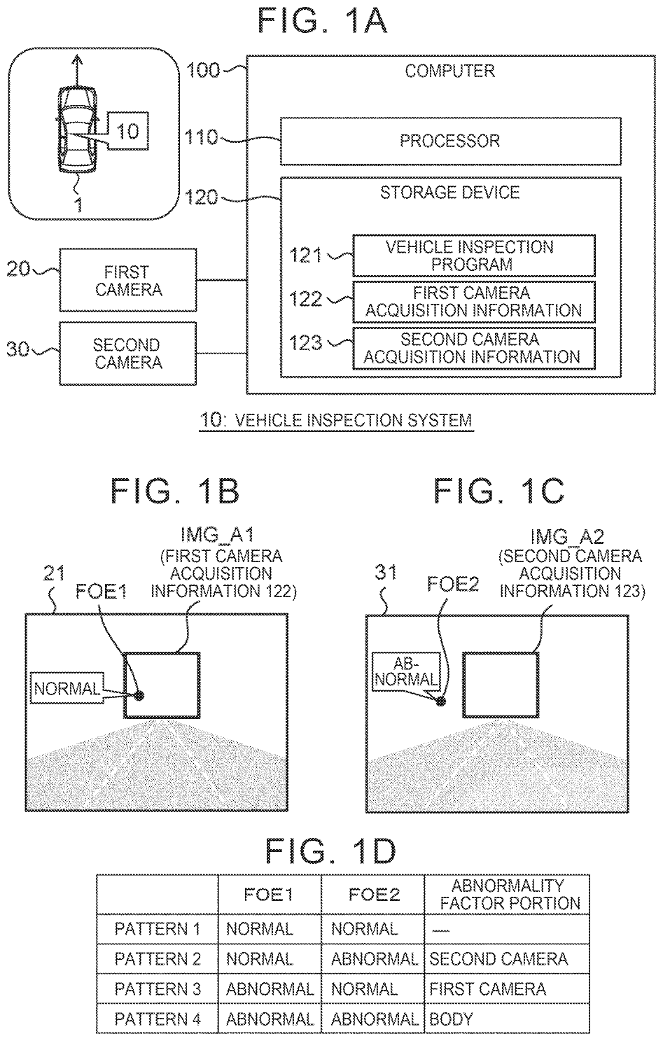

FIG. 1A is a block diagram illustrating an overview and a specific example of a vehicle inspection system 10 according to a first embodiment. As illustrated in FIG. 1A, the vehicle inspection system 10 is mounted on the vehicle 1 and inspects the vehicle 1. The vehicle 1 on which the vehicle inspection system 10 is mounted may be an autonomous vehicle. The vehicle inspection system 10 includes a first camera 20, a second camera 30, and a computer 100.

The first camera 20 is mounted in front of the vehicle 1 and detects a situation around the vehicle 1. The second camera 30 is mounted behind the vehicle 1 and detects a situation around the vehicle 1.

The computer 100 is connected to at least the first camera 20 and the second camera 30. The computer 100 includes one or more processors 110 (hereinafter simply referred to as processors 110) and one or more storage devices 120 (hereinafter simply referred to as storage devices 120). The processor 110 executes various processes. For example, the processor 110 includes a Central Processing Unit (CPU). The storage device 120 stores various types of information. Examples of the storage device 120 include volatile memory, non-volatile memory, Hard Disk Drive (HDD), Solid State Drive (SSD), and the like. Typically, the computer 100 is mounted on the vehicle 1.

The storage device 120 stores a vehicle inspection program 121, first camera acquisition information 122, second camera acquisition information 123, and the like.

The vehicle inspection program 121 is a computer program for inspecting the vehicle 1. When the processor 110 executes the vehicle inspection program 121, various kinds of processing by the computer 100 are realized. The vehicle inspection program 121 may be recorded in a recording medium readable by the computer 100.

The first camera acquisition information 122 includes a camera image (hereinafter, referred to as a first camera image) captured by the first camera 20 while the vehicle 1 is traveling. The second camera acquisition information 123 includes a camera image (hereinafter, referred to as a second camera image) captured by the second camera 30 while the vehicle 1 is traveling. The second camera image is captured by the second camera 30 at the same time as the first camera image is captured by the first camera 20.

Furthermore, the first camera acquisition information 122 and the second camera acquisition information 123 include object information about an object around the vehicle 1. Examples of objects around the vehicle 1 include pedestrians, other vehicles, white lines, road structures, obstacles, and the like. As another example, an object may be recognized and identified by analyzing an image obtained by a camera.

### 1-2. Examples

### 1-2-1. Example of Determination of Presence or Absence of Optical Axis Abnormality

The processor 110 determines the presence or absence of the optical axis abnormality of the first camera 20 and the second camera 30. Details of the determination example of the presence or absence of the optical axis abnormality will be described below.

The processor 110 acquires the first camera acquisition information 122 and the second camera acquisition information 123, and calculates optical axis coordinate values of the first camera 20 and the second camera 30, respectively. Specifically, the processor 110 calculates a first optical axis coordinate value FOE1, which is an optical axis coordinate value of the first camera 20, based on the first camera images 21, as shown in FIG. 1B. As shown in FIG. 1C, the processor 110 calculates a second optical axis coordinate value FOE2 which is an optical axis coordinate value of the second camera 30 based on the second camera images 31.

The first optical axis coordinate value FOE1 and the second optical axis coordinate value FOE2 are also referred to as, for example, an infinite distance point Focus Optical Expansion (FOE). Examples of the calculation of the first optical axis coordinate value FOE1 and the second optical axis coordinate value FOE2 include the technique of the reference document (JP 2011-081613 A). According to this document, the intersection point of the optical flow obtained from the characteristic point of the road structure or the like existing around the vehicle 1 is set as the optical axis coordinate value (FOE).

Further, the processor 110 determines the presence or absence of an optical axis anomaly for each of the calculated first optical axis coordinate value FOE1 and second optical axis coordinate value FOE2.

First, the determination of the presence or absence of an optical axis anomaly in the first optical axis coordinate value FOE1 will be described. As shown in FIG. 1B, the first camera acquisition information 122 further includes information on the first predetermined area IMG_A1. The first predetermined area IMG_A1 is an area of a predetermined size set at the center of a position at which the optical axis coordinate value is to be positioned in the first camera image 21, and means an image area indicating that the optical axis is not abnormal. Therefore, when the first optical axis coordinate value FOE1 is included in the first predetermined area IMG_A1, the processor 110 determines that the presence or absence of the optical axis abnormality is “none”. On the other hand, when the first optical axis coordinate value FOE1 is not included in the first predetermined area IMG_A1, the processor 110 determines that the presence or absence of the optical axis abnormality is “present”.

Next, the determination of the presence or absence of an optical axis anomaly in the second optical axis coordinate value FOE2 will be described. As shown in FIG. 1C, the second camera acquisition information 123 further includes information on the second predetermined area IMG_A2. The second predetermined area IMG_A2 is an area of a predetermined size set at the center of a position at which the optical axis coordinate value is to be positioned in the second camera image 31, and means an image area indicating that the optical axis is not abnormal. Therefore, when the second optical axis coordinate value FOE2 is included in the second predetermined area IMG_A2, the processor 110 determines that the presence or absence of the optical axis abnormality is “none”. On the other hand, when the second optical axis coordinate value FOE2 is not included in the second predetermined area IMG_A2, the processor 110 determines that the presence or absence of the optical axis abnormality is “present”. The size of the second predetermined region IMG_A2 may be different from or the same as the size of the first predetermined region IMG_A1.

The presence or absence of an optical axis abnormality may be determined based on the number of times the optical axis coordinate value (FOE) becomes abnormal. For example, when the number of times the first optical axis coordinate value FOE1 protrudes from the first predetermined region IMG_A1 is equal to or more than the set reference number, the presence or absence of the optical axis abnormality is determined to be “presence”. The reference number may be different between the first optical axis coordinate value FOE1 and the second optical axis coordinate value FOE2, or may be the same.

### 1-2-2. Evaluation Example of Abnormality Factor Portion

After the determination of the presence or absence of the optical axis abnormality is performed, the processor 110 identifies the abnormality factor portion causing the optical axis abnormality. Specifically, the abnormality factor portion is identified on the basis of the presence or absence of an abnormality in the first optical axis coordinate value FOE1 and the presence or absence of an abnormality in the second optical axis coordinate value FOE2. For example, as shown in FIG. 1D, it is assumed that an anomaly occurs in one of the first optical axis coordinate value FOE1 and the second optical axis coordinate value FOE2 (pattern 2 and pattern 3). In this case, there is a high possibility that the camera corresponding to the optical axis coordinate value in which the abnormality has occurred is an abnormality factor portion. Therefore, in the case of the pattern 2, the abnormality factor portion is determined as the second camera 30, and in the case of the pattern 3, the abnormality factor portion is determined as the first camera 20.

On the other hand, as shown in the pattern 4 in FIG. 1D, it is assumed that both the first optical axis coordinate value FOE1 and the second optical axis coordinate value FOE2 are abnormal. In this case, even if both of the first optical axis coordinate value FOE1 and the second optical axis coordinate value FOE2 are abnormal, it is unlikely that both of the first camera 20 and the second camera 30 are abnormality factor portions. Rather, it is highly likely that both the first optical axis coordinate value FOE1 and the second optical axis coordinate value FOE2 are abnormal due to the vehicle body of the vehicle to which the first camera 20 and the second camera 30 are attached. Therefore, in the case of the pattern 4, the abnormality occurrence place is determined to be the vehicle body of the vehicle 1.

As described above, in the vehicle inspection system 10 according to the first embodiment, the presence or absence of an anomaly is determined for each of the first optical axis coordinate value FOE1 and the second optical axis coordinate value FOE2. Further, according to the vehicle inspection system 10, an abnormality factor portion causing an abnormality in one or both of the first optical axis coordinate value FOE1 and the second optical axis coordinate value FOE2 is identified from among the first camera 20, the second camera 30, and the vehicle body of the vehicle based on the presence or absence of an abnormality in the first optical axis coordinate value FOE1 and the presence or absence of an abnormality in the second optical axis coordinate value FOE2. Thus, even when an optical axis abnormality occurs, an abnormality factor portion can be identified in a short time. Further, it is possible to perform repair only at a place where repair is required.

### 1-3. Example of Processing

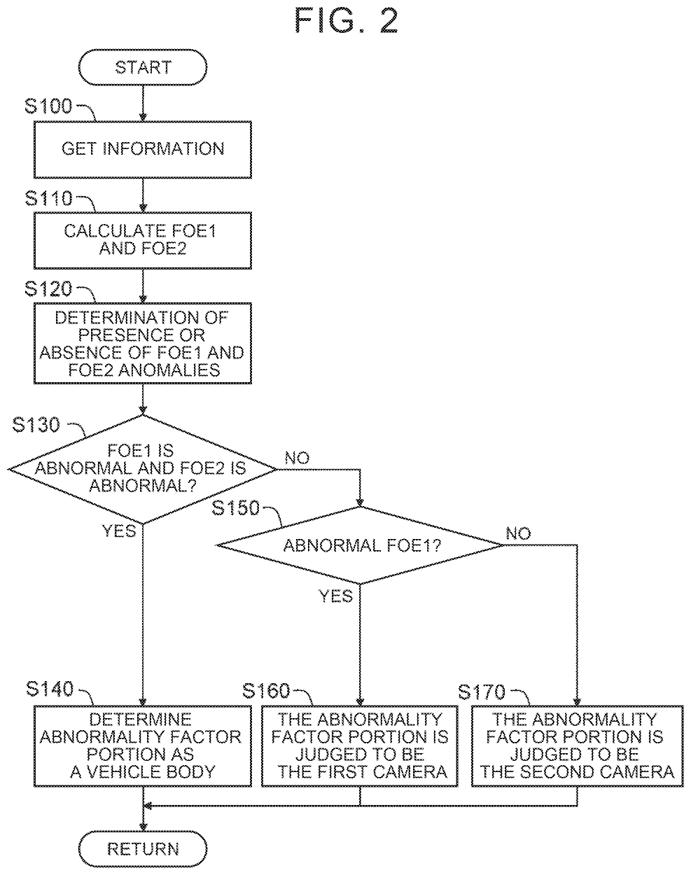

FIG. 2 is a flowchart illustrating a processing example of the vehicle inspection system 10 according to the first embodiment.

In S100, the processor 110 acquires various kinds of information such as the first camera acquisition information 122, the second camera acquisition information 123, and the like. Thereafter, the process proceeds to S110.

In S110, the processor 110 calculates a first optical axis coordinate value FOE1 based on the first camera acquisition information 122, and calculates a second optical axis coordinate value FOE2 based on the second camera acquisition information 123. Thereafter, the process proceeds to S120.

In S120, the processor 110 determines whether or not there is an abnormality in the first optical axis coordinate value FOE1, and determines whether or not there is an abnormality in the second optical axis coordinate value FOE2. Thereafter, the process proceeds to S130.

In S130, the processor 110 determines whether or not the first optical axis coordinate value FOE1 is abnormal and the second optical axis coordinate value FOE2 is abnormal. If it is determined that this condition is satisfied (S130;Yes), the process proceeds to S140. Otherwise (S130;No), the process proceeds to S150.

In S140, the processor 110 determines, as the vehicle body of the vehicle, an abnormality factor portion that causes an abnormality in both the first optical axis coordinate value FOE1 and the second optical axis coordinate value FOE2.

In S150, the processor 110 determines whether or not there is an anomaly in the first optical axis coordinate value FOE1. If it is determined that there is an anomaly in the first optical axis coordinate value FOE1 (S150;Yes), the process proceeds to S160. Otherwise (S150;No), the process proceeds to S170.

In S160, the processor 110 determines that an abnormality factor portion that causes an abnormality only in the first optical axis coordinate value FOE1 is the first camera 20.

In S170, the processor 110 determines that an abnormality factor portion that causes an abnormality only in the second optical axis coordinate value FOE2 is the second camera 30.

### 2. Embodiment 2

### 2-1. Outline

In the vehicle inspection system 10 according to the first embodiment, when both of the first optical axis coordinate value FOE1 and the second optical axis coordinate value FOE2 are abnormal, it is determined that the abnormality factor portion is the vehicle body of the vehicle 1. However, the abnormality factor of the vehicle body determined as the abnormality factor portion varies. Therefore, according to the vehicle inspection system 10 of the second embodiment, when it is determined that the abnormality factor portion is the vehicle body, the abnormality cause of the vehicle body is further estimated. Thus, in addition to the effects of the first embodiment, it is possible to clarify a portion requiring repair. Hereinafter, differences from the first embodiment will be mainly described.

Here, an abnormality factor estimated when the abnormality factor portion is a vehicle body will be considered. When the total loading amount of the rear seat or the luggage compartment located at the rear portion of the vehicle body exceeds the maximum loading amount (that is, when the vehicle 1 is in an overloaded state), it is assumed that the vehicle body cannot be maintained horizontally and the rear portion of the vehicle body is inclined so as to sink to the ground side with respect to the horizontal. Therefore, as an example of the abnormality factor of the vehicle body, it is assumed that the vehicle height at the rear portion of the vehicle body is significantly lowered. The rear portion of the vehicle body is typically provided with a height sensor capable of measuring the vehicle height. Therefore, according to the vehicle inspection system 10 according to the second embodiment, it is estimated whether or not the abnormality factor in the case where the abnormality factor portion is the vehicle body is the overloading of the vehicle 1 based on the vehicle height information obtained from the height sensor.

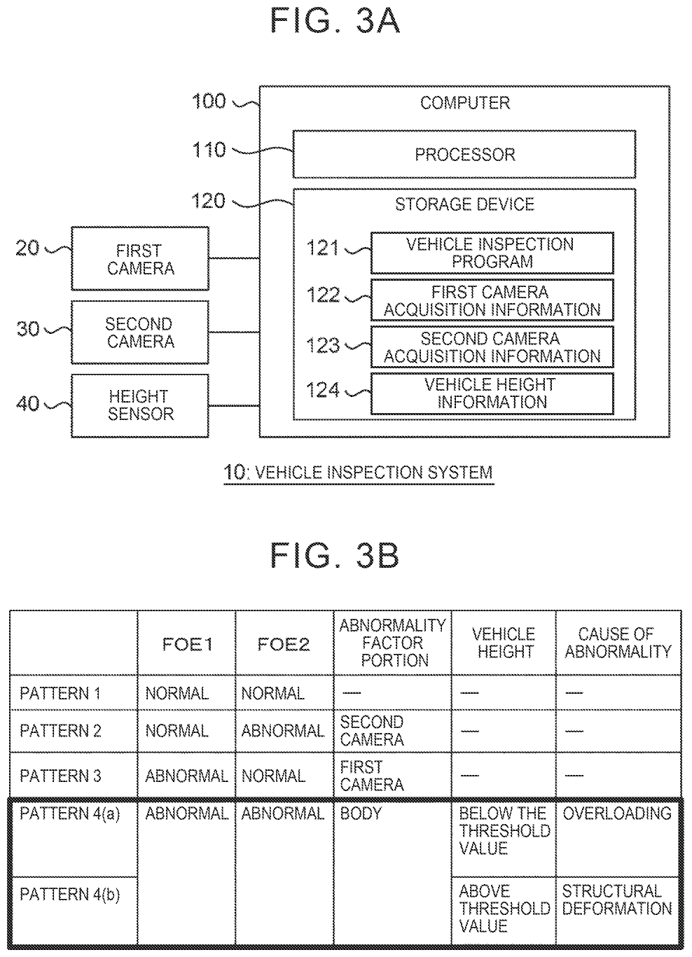

FIG. 3A is a block diagram illustrating an overview and a specific example of a vehicle inspection system 10 according to a second embodiment of the present disclosure. Specifically, as shown in FIG. 3A, the vehicle inspection system 10 further includes a height sensor 40. As described above, the height sensor 40 is a sensor that is provided on the vehicle body and measures the vehicle height of the vehicle body. The storage device 120 further stores vehicle height information 124 acquired from the height sensor 40.

### 2-2. Examples

In the above-described example of determining the abnormality factor portion, when it is determined that the abnormality factor portion is the vehicle body, the processor 110 estimates the abnormality factor based on the vehicle height information 124. Specifically, as shown in FIG. 3B, the processor 110 estimates that the abnormal factor is overloaded on the vehicle 1 when the vehicle body is identified as the abnormality factor portion and the vehicle height acquired from the height sensor 40 is less than the threshold value (pattern 4(a)). On the other hand, in a case where the vehicle height acquired from the height sensor 40 is equal to or higher than the threshold value (pattern 4(b)), that is, in a case where the abnormality factor is not overloading of the vehicle 1, it is assumed that the structure of the vehicle body is deformed. Therefore, in this case, the processor 110 estimates the abnormality factor as the structural deformation of the vehicle body.

### 2-3. Example of Processing

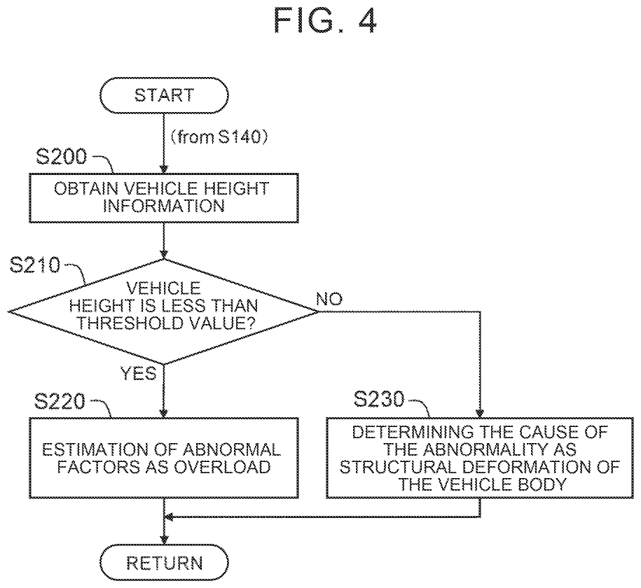

FIG. 4 is a flowchart illustrating a processing example of the vehicle inspection system 10 according to the second embodiment.

In S200, the processor 110 acquires the vehicle height information 124 when it is determined that the abnormality factor portion is the vehicle body in the above-described S140. Thereafter, the process proceeds to S210.

In S210, the processor 110 determines whether the vehicle height is less than a threshold value. If it is determined that the vehicle height is less than the threshold value (S210;Yes), the process proceeds to S220. Otherwise (S210;No), the process proceeds to S230.

In S220, the processor 110 estimates an abnormal factor as an overload of the vehicles 1.

In S230, the processor 110 estimates the abnormal factor as a structural deformation of the vehicle body.

### 3. Embodiment 3

### 3-1. Overview

In the vehicle inspection system 10 according to the first embodiment, when there is an abnormality in one of the first optical axis coordinate value FOE1 and the second optical axis coordinate value FOE2, it is determined that the abnormality factor portion is a camera corresponding to an optical axis coordinate value having an abnormality (that is, the first camera 20 or the second camera 30). However, there are various abnormality factors of the camera. Therefore, according to the vehicle inspection system 10 of the third embodiment, when it is determined that the abnormality factor portion is the first camera 20 or the second camera 30, the abnormality cause of the camera is further estimated. Thus, in addition to the effects of the first embodiment, it is possible to clarify a portion requiring repair. Hereinafter, differences from the first embodiment will be mainly described.

Here, an abnormality factor in a case where the abnormality factor portion is the first camera 20 or the second camera 30 will be considered. The camera mounted on the vehicle 1 is fixedly attached to the vehicle body. Therefore, as an example of an abnormality factor of the camera, it is assumed that the position of the camera attached to the vehicle body is displaced due to vibration of the vehicle 1 during traveling of the vehicle 1 or the like. Therefore, according to the vehicle inspection system 10 according to the second embodiment, when the abnormality factor portion is the first camera 20 or the second camera 30, it is estimated whether or not the abnormality factor is a deviation of the position of the camera based on the information that detects the deviation of the position of the camera.

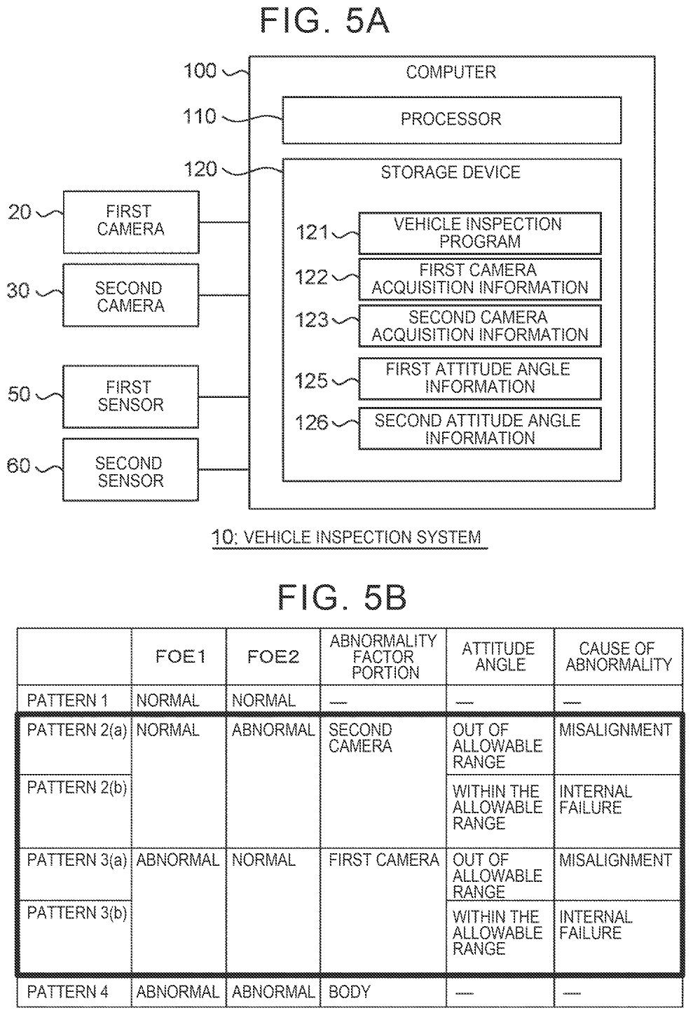

FIG. 5A is a block diagram illustrating an overview and a specific example of a vehicle inspection system 10 according to a third embodiment of the present disclosure. Specifically, as shown in FIG. 5A, the vehicle inspection system 10 further includes a first sensor 50 and a second sensor 60. The first sensor 50 is attached to the first camera 20 and measures an attitude angle of the first camera 20. The second sensor 60 is attached to the second camera 30 and measures an attitude angle of the second camera 30. The storage device 120 further stores first attitude angle information 125 acquired from the first sensor 50 and second attitude angle information 126 acquired from the second sensor 60. Examples of the sensor for measuring the attitude angle include a gyro sensor and the like. The attitude angle is indicated by, for example, a rotational angle in Yaw direction, Pitch direction, and Roll direction.

### 3-2. Examples

In the above-described example of determining the abnormality factor portion, when it is determined that the abnormality factor portion is the first camera 20, the processor 110 estimates the abnormality factor based on the first attitude angle information 125. Specifically, as shown in FIG. 5B, when the second camera 30 is identified as an abnormality factor portion and the attitude angle (second attitude angle) of the second camera 30 acquired from the second sensor 60 is outside the allowable range (pattern 2(a)), the processor 110 estimates the abnormal factor as a deviation of the position of the second camera 30 attached to the vehicle body. On the other hand, when the second attitude angle is within the allowable range (pattern 2(b)), it is assumed that the inside of the second camera 30 has failed. Therefore, in this case, the processor 110 estimates the abnormality factor as a failure inside the second camera 30. Note that, in the above-described example of determining the abnormality factor portion, when it is determined that the abnormality factor portion is the first camera 20, the same processing as that of the second camera 30 is performed, and thus the description thereof will be omitted.

### 3-3. Example of Processing

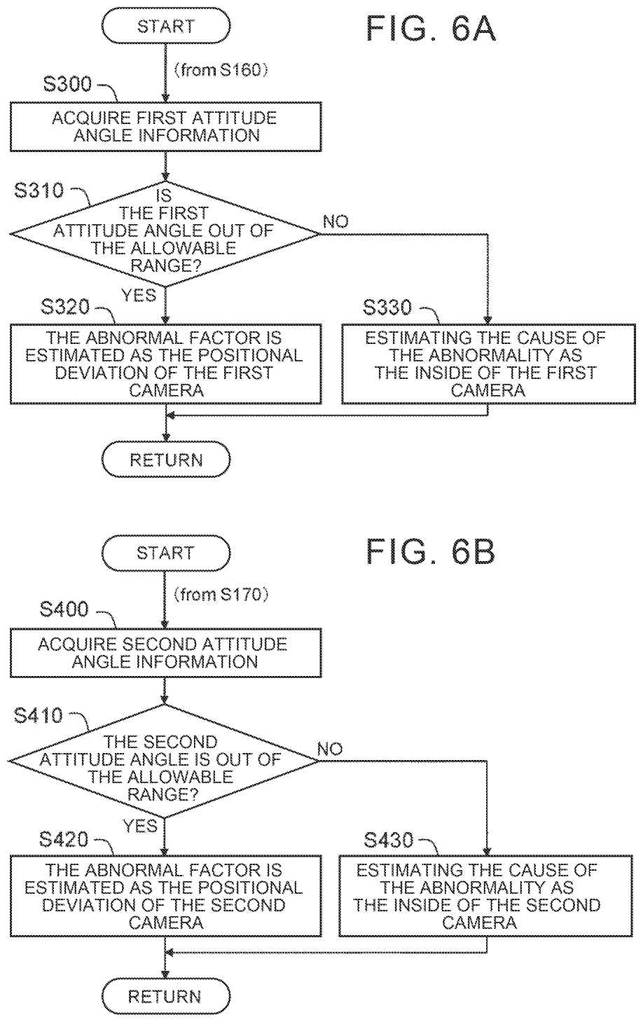

FIG. 6A is a flow chart showing an exemplary process of the vehicle inspection system 10 according to the third embodiment. Specifically, FIG. 6A is a flowchart of a processing example of estimating an abnormality factor of the first camera 20, and FIG. 6B is a flowchart of a processing example of estimating an abnormality factor of the second camera 30.

According to the flow chart of FIG. 6A, in S300, the processor 110 acquires the first attitude angle information 125 when it is determined in the above-described S160 that the abnormality factor portion is the first camera 20. Thereafter, the process proceeds to S310.

In S310, the processor 110 determines whether the first attitude angle is out of tolerance. When it is determined that the first attitude angle is outside the allowable range (S310;Yes), the process proceeds to S320. Otherwise (S310;No), the process proceeds to S330.

In S320, the processor 110 estimates the abnormal factor as a displacement of the position of the first camera 20.

In S330, the processor 110 estimates an abnormal factor as a failure inside the first camera 20.

Note that in S400-S430 shown in the flow chart of FIG. 6B, the same processes as those in the above-described S300-S330 are performed, and therefore, the explanation thereof is omitted here.

### 4. Other Embodiments

### 4-1. First Example

According to the vehicle inspection system 10 according to the other embodiment, after the above-described estimation of the abnormality factor is performed, an alarm prompting repair of a portion requiring repair is notified to the occupant. This makes it possible to perform diagnosis and repair by a dealer or the like at an early stage. The portion requiring repair means that the abnormality factor includes any one of a failure or a displacement of the position inside the first camera 20, a failure or a displacement of the position inside the second camera 30, and a structural deformation of the vehicle body as the abnormality factor.

### 4-2. Second Example

According to the vehicle inspection system 10 according to another embodiment, the result of at least one of the determination result of the abnormality factor portion and the estimation result of the abnormality cause is held even if the engine is restarted. Accordingly, even when the abnormality factor portion is normally restored due to the restart of the engine, the occupant is continuously notified of the information on the result of the determination that the abnormality has been once detected. Therefore, diagnosis and repair by a dealer or the like can be performed at an early stage.

What is claimed is:

1. A vehicle inspection system for inspecting a vehicle, the vehicle inspection system comprising a computer connected to a first camera mounted on a front portion of the vehicle and a second camera mounted on a rear portion of the vehicle, wherein the computer is configured to execute processes including:
acquiring a first camera image captured by the first camera while the vehicle is traveling, and acquiring a second camera image captured by the second camera simultaneously with capturing the first camera image by the first camera;
calculating a first optical axis coordinate value from the first camera image;
calculating a second optical axis coordinate value from the second camera image;
determining presence or absence of an abnormality in each of the first optical axis coordinate value and the second optical axis coordinate value; and
identifying, based on a combination of the presence or absence of the abnormality in the first optical axis coordinate value and the presence or absence of the abnormality in the second optical axis coordinate value, an abnormality factor portion causing the abnormality in one or both of the first optical axis coordinate value and the second optical axis coordinate value from among the first camera, the second camera, and a vehicle body of the vehicle.

2. The vehicle inspection system according to claim 1, wherein the computer is configured to execute processes including:
identifying the abnormality factor portion as the first camera, when the abnormality is found in the first optical axis coordinate value and the abnormality is not found in the second optical axis coordinate value;
determining the abnormality factor portion as the second camera, when the abnormality is found in the second optical axis coordinate value and the abnormality is not found in the first optical axis coordinate value; and
identifying the abnormality factor portion as the vehicle body, when the abnormality is found in each of the first optical axis coordinate value and the second optical axis coordinate value.

3. The vehicle inspection system according to claim 2, further comprising a height sensor provided on the vehicle body, wherein the computer is configured to execute processes including:
estimating an abnormal factor as a structural deformation of the vehicle body, when the vehicle body is identified as the abnormality factor portion, and a vehicle height acquired from the height sensor is equal to or higher than a threshold value; and
estimating the abnormal factor as overloading on the vehicle, when the vehicle body is identified as the abnormality factor portion, and the vehicle height is less than the threshold value.

4. The vehicle inspection system according to claim 2, further comprising a first sensor for measuring an attitude angle of the first camera and a second sensor for measuring an attitude angle of the second camera, wherein the computer is configured to execute processes including:
estimating an abnormal factor as a failure inside the first camera, when the first camera is identified as the abnormality factor portion, and a first attitude angle acquired from the first sensor is within an allowable range;
estimating the abnormal factor as misalignment of the first camera mounted on the vehicle body, when the first camera is identified as the abnormality factor portion, and the first attitude angle is outside the allowable range;
estimating the abnormal factor as a failure inside the second camera, when the second camera is identified as the abnormality factor portion, and a second attitude angle acquired from the second sensor is within the allowable range; and
estimating the abnormal factor as misalignment of the second camera mounted on the vehicle body, when the second camera is identified as the abnormality factor portion, and the second attitude angle is outside the allowable range.

5. A vehicle inspection method for inspecting a vehicle, the vehicle inspection method executing processes comprising:
acquiring a first camera image captured by a first camera mounted on a front portion of the vehicle while the vehicle is traveling, and acquiring a second camera image captured by a second camera mounted on a rear portion of the vehicle simultaneously with capturing the first camera image by the first camera;
calculating a first optical axis coordinate value from the first camera image;
calculating a second optical axis coordinate value from the second camera image;
determining presence or absence of an abnormality in each of the first optical axis coordinate value and the second optical axis coordinate value; and
identifying, based on a combination of the presence or absence of the abnormality in the first optical axis coordinate value and the presence or absence of the abnormality in the second optical axis coordinate value, an abnormality factor portion causing the abnormality in one or both of the first optical axis coordinate value and the second optical axis coordinate value from among the first camera, the second camera, and a vehicle body of the vehicle.
